(19) United States
(12) Patent Application Publication
(10) Pub. No.: US 2005/0263633 A1
(43) Pub. Date: Dec. 1, 2005

(54) Serrated scissor ring, comminuting apparatus, and method

(76) Inventor: Dale L. Vantrease, Selah, WA (US)

Correspondence Address: WELLS ST. JOHN P.S., 601 W. FIRST AVENUE, SUITE 1300, SPOKANE, WA, 99201, US

(21) Appl. No.: 10/853,940

(22) Filed: May 25, 2004

(51) Int. Cl. B02C 18/16

(52) U.S. Cl. 241/236

(57) ABSTRACT

A rotating scissor ring is provided with a disk-shaped body, a first set of first finger knives, and a second set of second finger knives. The disk-shaped body has an outer peripheral surface. The first set of first finger knives is spaced apart about the outer peripheral surface. The second set of second finger knives is subdivided into a plurality of groups of second finger knives. The second finger knives are geometrically distinct from the first finger knives. Each group includes a plurality of second finger knives provided between a pair of adjacent first finger knives. A method is also provided.

### TECHNICAL FIELD

This invention pertains to apparatus for comminuting solid waste materials. More particularly, the present invention relates to knives, scissor rings, machines and methods for comminuting solid waste materials such as plastic and foam plastic sheet material.

### BACKGROUND OF THE INVENTION

Recycling of plastic and foam plastic material is well known in the thermoforming art, and is widely practiced in the thermoforming industry. During the manufacture and forming of many molded plastic products, significant amounts of plastic waste material are frequently produced. Accordingly, recycling machines subdivide the plastic or foam plastic waste material so that it can be reused to form new sheets of plastic or foam plastic material for subsequent re-use in a thermoforming operation.

Jere F. Irwin has previously invented numerous unique apparatus for comminuting waste material, particularly plastic and foam plastic sheet material, into small, rather uniform particles or pieces that can be readily recycled or disposed in an environmentally acceptable manner. Numerous generations of comminuting apparatus developed by Jere F. Irwin have been sold by Irwin Research and Development, Inc., of Yakima, Wash., under the product name CHESAW® and have gained commercial success. For example, such apparatus include apparatus taught in U.S. Pat. Nos. 4,687,144; 5,836,527; 5,860,607; 5,893,523; 6,357,680; 6,644,570; 6,644,573; and 6,695,239, herein incorporated by reference.

U.S. Pat. No. 5,893,523 was commercially embodied in a CHESAW® Model CLS comminuting apparatus, sold by Irwin Research and Development, Inc. Construction details of an original version of such comminuting apparatus are disclosed in U.S. Pat. No. 5,893,523, herein incorporated by reference. FIGS. 8-10 illustrate the manner in which scissor rings of this comminuting apparatus co-act to subdivide waste material. After a single pass through such comminuting apparatus, strips of material are generated, as identified in FIG. 16. The strips are further subdivided by recirculating the strips to pass one or more additional times between the scissor rings.

According to FIG. 8, a pair of co-acting prior art scissor rings 1072 is shown mounted on separate drive shafts 1062 and 1066 that are configured to rotate in counter-rotation parallel with one another. There is sufficient overlap between scissor rings 1072 on each shaft 1062 and 1066 to shear a sheet 12 of material between the scissor rings as the material passes between the scissor rings on each shaft 1062 and 1066. It is understood that a plurality of scissor rings 1072 are provided on each shaft 1062 and 1066 in overlapping and internesting relation, with a ring spacer 1102 being provided opposite each scissor ring 1072.

Each scissor ring 1072 includes seven finger knives spaced equally about an outer circumference of the scissor ring 1072. In operation, finger knives 1072 grip, puncture and transverse a cuttage piece of sheet 12 as it is being sheared between scissor rings 1072.

As depicted in FIG. 8-10, scissor rings 1072 are mounted within a comminuting apparatus similar to that depicted in U.S. Pat. No. 5,893,523. Shafts 1062 and 1066 are analogous to shafts 62 and 66 in the comminuting apparatus of FIGS. 1-7. A modern version of such comminuting apparatus is depicted in reference to FIGS. 1-5, except that modifications are included that add features of the present invention wherein newly designed scissor rings replace prior art scissor rings 1072, and a newly designed separator screen replaces the separator screen depicted in U.S. Pat. No. 5,893,523.

FIG. 9 illustrates the overlapping and internesting cooperation of three selected scissor rings 1072 as a sheet of foam plastic material 12 is received between three co-acting scissor rings 1072. It is understood that the three scissor rings 1072 depicted in FIGS. 9 and 10 are only three scissor rings selected from a larger number of scissor rings provided on two internesting scissor rolls and extending along essentially the entire length of each of the scissor rolls. As sheet 12 is delivered upward and between co-acting and counter-rotating scissor rings 1072, individual finger knives 1082 puncture, pierce, grab and pull upwardly on sheet 12. The net effect is that sheet 12 is imparted with lateral sheet tension as a plurality of such scissor rings grab along an entire top edge of sheet 12. As sheet 12 is advanced upward between scissor rings 1072, finger knives 1082 puncture, grab and tear at sheet 12, while smooth arcuate edges between adjacent finger knives 1082 cooperate to create a scissor action that cleanly severs the top edge of sheet 12 into a strip of material.

As shown in FIG. 10, a resulting strip 1188 from sheet 12 is upwardly separated and removed from sheet 12 by the co-action of three overlapping, internesting, and adjacent scissor knives 1072. In order to simplify illustration, only a single strip 1188 is shown in FIG. 10. However, it is understood that a plurality of strips 1188 are severed adjacent to one another from sheet 12 via co-action of each scissor ring 1072 with an adjacent pair of opposed scissor rings. It is further understood that the positioning of a finger knife 1082 at a 9:00 o'clock position, as depicted in FIG. 8, on shaft 1062 will cause severing of a strip from sheet 12. One exemplary resulting strip 1188 is depicted with reference to FIG. 16.

A set of three overlapping and internesting scissor rings 1072, as shown in FIGS. 8-10, thereby cooperate to generate a strip 1188 (see FIG. 16). Scissor rings 1072 can be incorporated into any of a number of comminuting apparatus having adjacent, overlapping, and internesting scissor rolls. Strips 1188 are then recirculated around and back between scissor rings 1072 of a pair of internesting scissor rolls for further subdividing and separating out of smaller, subdivided pieces through a separator screen, as described in U.S. Pat. No. 5,893,523. However, there exists a need to improve the volumetric capacity for a comminuting device so that more material can be severed and subdivided to a desired sorted size of subdivided pieces than is presently provided by using the prior art scissor rings depicted in FIGS. 8-10.

Accordingly, improvements are needed in the manner in which strips of material are severed from a sheet of material using a comminuting apparatus.

### SUMMARY OF THE INVENTION

A rotating scissor ring is provided comprising a rotary cutting knife body configured for use within a comminuting apparatus. The rotating scissor ring has a radially fluctuating outer peripheral surface that forms a pair of serrated edges with respective sides of the scissor ring. The outer peripheral surface provides a pair of parallel, serrated shearing edges that cooperate with adjacent shearing edges of scissor rings on an adjacent, overlapping, and internesting scissor roll to puncture, tear, and shear a crinkled strip of material from a sheet of material that is introduced between the adjacent scissor rolls. Multiple crinkled strips are cut by many adjacent scissor rings placed on each overlapping scissor roll. In one case, a scissor ring has a first set of first finger knives spaced apart on an outer peripheral surface and a second set of second finger knives provided in groups between adjacent pairs of adjacent first finger knives. In one case, the first finger knives are larger than the second finger knives.

According to one aspect, a rotating scissor ring is provided with a disk-shaped body, a first set of first finger knives, and a second set of second finger knives. The disk-shaped body has an outer peripheral surface. The first set of first finger knives is spaced apart about the outer peripheral surface. The second set of second finger knives is subdivided into a plurality of groups of second finger knives. The second finger knives are geometrically distinct from the first finger knives. Each group includes a plurality of second finger knives provided between a pair of adjacent first finger knives.

According to another aspect, a rotary cutting knife body is provided with a disk-shaped scissor ring. The disk-shaped scissor ring has an outer peripheral surface including a circumferential array of first finger knives and second finger knives spaced apart about the outer peripheral surface. The first finger knives have a sharp knife point that extends radially outwardly a greater distance than a corresponding sharp knife point on the second finger knives, with a plurality of the second finger knives distributed between each adjacent pair of first finger knives.

According to yet another aspect, a comminuting apparatus is provided with a frame, a set of overlapping scissor rolls, and a recycle manifold. The frame has an entrance opening for receiving waste material. The set of overlapping scissor rolls is carried for rotation by the frame. Each scissor roll includes a plurality of disk-shaped scissor rings having an outer peripheral surface with a circumferential array of first finger knives and second finger knives spaced apart about the outer peripheral surface. The first finger knives have a sharp knife point that extends radially outwardly a distance greater than a corresponding sharp knife point on the second finger knives, with a plurality of the second finger knives distributed between each adjacent pair of first finger knives. The recycle manifold is provided downstream of the scissor rolls and is configured to receive subdivided pieces of waste material.

According to yet even another aspect, a method is provided for subdividing plastic waste material. The method includes: providing a pair of overlapping scissor rolls and three adjacent, overlapping scissor rings, one scissor ring on one scissor roll and two scissor rings on another scissor roll, each scissor ring having an outer peripheral surface with a circumferential array of relatively large finger knives and a plurality of relatively small finger knives provided between each pair of adjacent relatively large finger knives, the relatively large and small finger knives of the outer peripheral surface cooperating with opposed sides of the scissor ring to provide a pair of serrated shearing edges; counter-rotating the pair of overlapping scissor rolls; moving a web of plastic material between the pair of counter-rotating, overlapping scissor rolls; severing a strip of material from the sheet of material along side edges via the three adjacent, overlapping scissor rolls; crinkling the strip of material as the material passes through an overlap zone of the serrated shearing edges cooperating between the three adjacent scissor rings; and severing the strip of material between the three overlapping scissor rings with one of the first finger knives on the one scissor ring as the one, first finger knife approaches a maximum overlap depth relative to the opposed, adjacent scissor rings so as to sever the strip at a trailing end from the sheet of material

### BRIEF DESCRIPTION OF THE DRAWINGS

Preferred embodiments of the invention are described below with reference to the following accompanying drawings.

FIG. 1 is a simplified plan view of a preferred embodiment of the apparatus illustrating the top exterior of the apparatus according to one aspect of the present invention.

FIG. 2 is a front view of the apparatus illustrated in FIG. 1.

FIG. 3 is a right side view of the apparatus illustrated in FIGS. 1 and 2.

FIG. 4 is a left side view of the apparatus illustrated in FIGS. 1-3 with a scissor roll gear cover removed to illustrate co-rotating associated gears.

FIG. 5 is an enlarged transverse vertical cross-sectional and partial view taken along line 5-5 in FIG. 1 illustrating the interior of the apparatus.

FIG. 6 is a partial perspective view of a pair of scissor rolls as seen from below and removed from the apparatus of FIGS. 1-5.

FIG. 7 is an enlarged partial perspective view of one scissor roll of FIG. 6 taken from the encircled region 7 of FIG. 6.

FIG. 8 is an isolated vertical cross-sectional view taken at a location corresponding with the location of line 13-13 of FIG. 19, but showing an alternative construction, that incorporates a set of prior art scissor rings on respective drive shafts with the initial entrance and feeding of a sheet of waste material between the scissor rolls.

FIG. 9 is a partial perspective view of three co-acting prior art scissor rings of FIG. 8 and illustrating a sheet of foam plastic material being received into an entrance nip between adjacent, intermeshing scissor rolls.

FIG. 10 is a partial perspective view of the three co-acting prior art scissor rings of FIG. 9 illustrating the sheet of foam plastic material exiting in strips via the exit nip.

FIG. 11 is a partial perspective view of three co-acting scissor rings of the present invention and illustrating a sheet of foam plastic material being received into the entrance nip.

FIG. 12 is a partial perspective view of the three co-acting scissor rings of FIG. 11 illustrating the sheet of foam plastic material exiting in crinkled strips via the exit nip.

FIG. 13 is an isolated vertical cross-sectional view taken along line 13-13 of FIG. 19 of a set of scissor roll rings and drive shafts and illustrating the initial entrance and feeding of a sheet of foam plastic waste material between the scissor rolls.

FIG. 14 is an isolated vertical cross-sectional view similar to FIG. 13 taken along line 14-14 of FIG. 19, except taken later in time and showing the scissor rings incrementally rotated to feed and sever the sheet of waste material.

FIG. 15 is an isolated vertical cross-sectional view similar to FIG. 14 taken along line 15-15 of FIG. 19, except taken later in time and showing the scissor rings further incrementally rotated to sever the sheet of waste material by cutting and tearing the sheet of waste material.

FIG. 16 is an enlarged isometric view of a subdivided piece or strip of foam plastic material generated via the prior art scissor rings of FIGS. 8-10.

FIG. 17 is an enlarged isometric view of a subdivided piece or strip of foam plastic material generated via the scissor rings of FIGS. 1-7, 11-15 and 19.

FIG. 18 is a series of illustration views of the waste material and the reduction of the waste material into smaller and smaller particles of the material as it is progressively processed and reduced to a desired particulate size.

FIG. 19 is a cross-sectional view taken along line 19-19 of FIG. 4.

FIG. 20 is an enlarged partial view of the separator screen taken along line 20-20 of FIG. 5, but with the scissor rolls removed.

FIG. 21 is a further enlarged partial view of selected perforations in the separator screen taken within the bounded region 21 of FIG. 20.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to a preferred embodiment of Applicant's invention. More particularly, a comminuting apparatus is provided with a new scissor ring and a separator screen that cooperate to provide increased operating speed, efficiency, and effectiveness. While the invention is described by way of a preferred embodiment, it is understood that the description is not intended to limit the invention to such embodiment, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

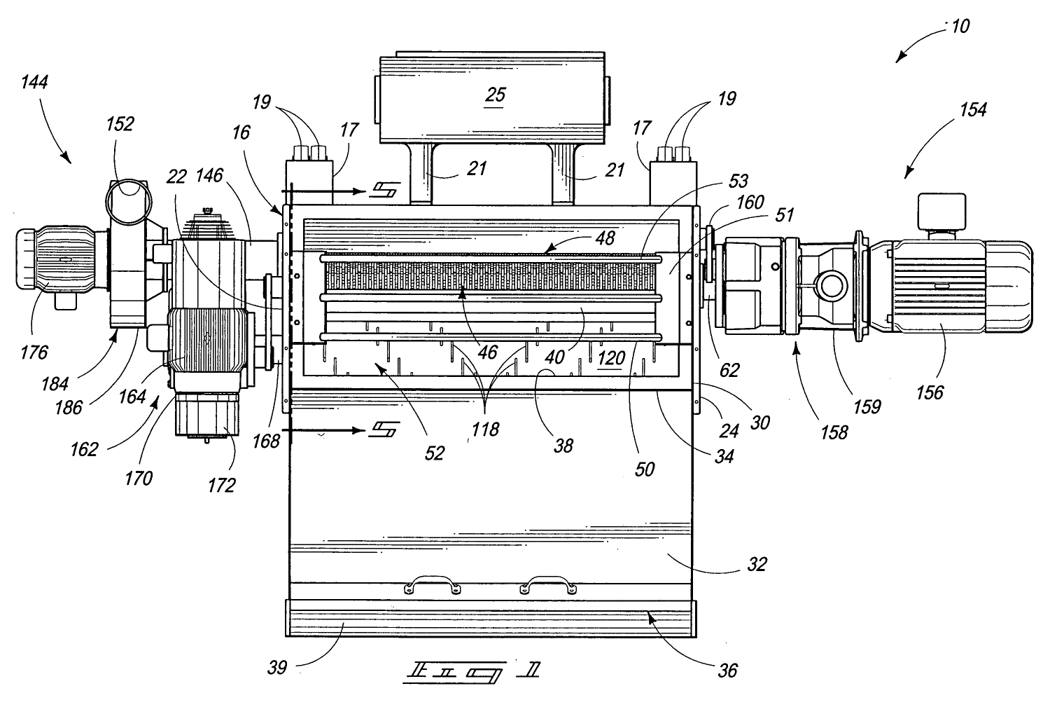

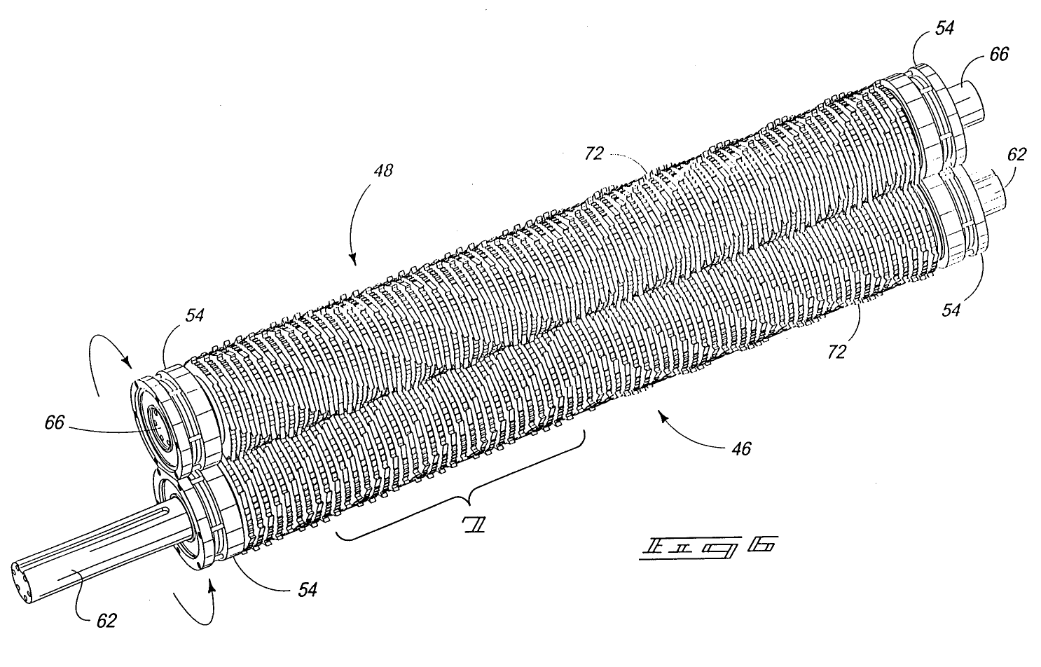

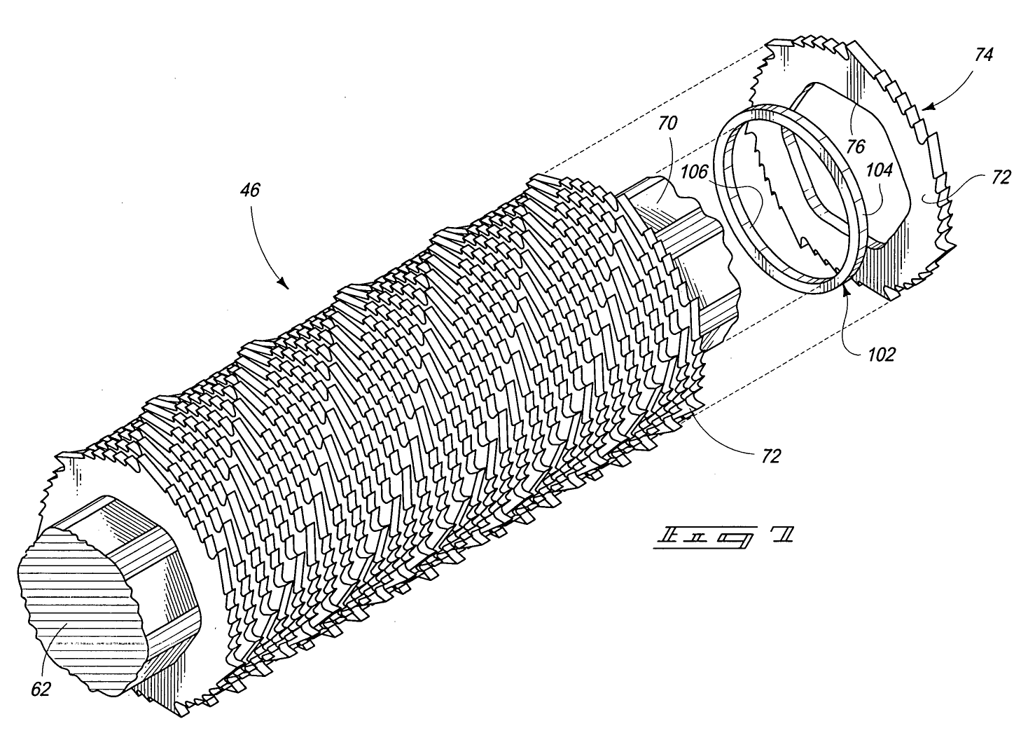

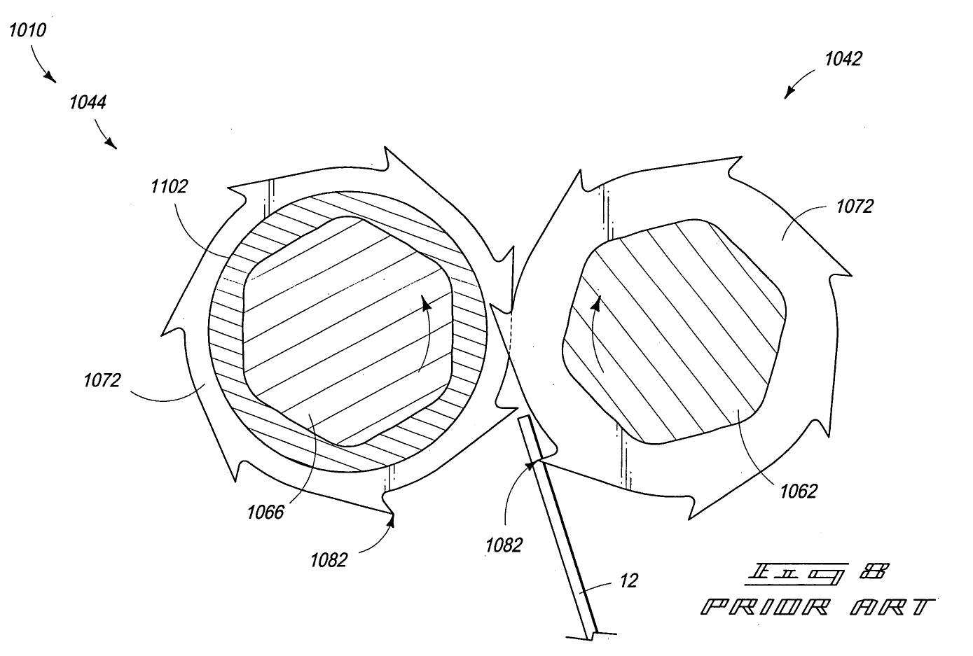

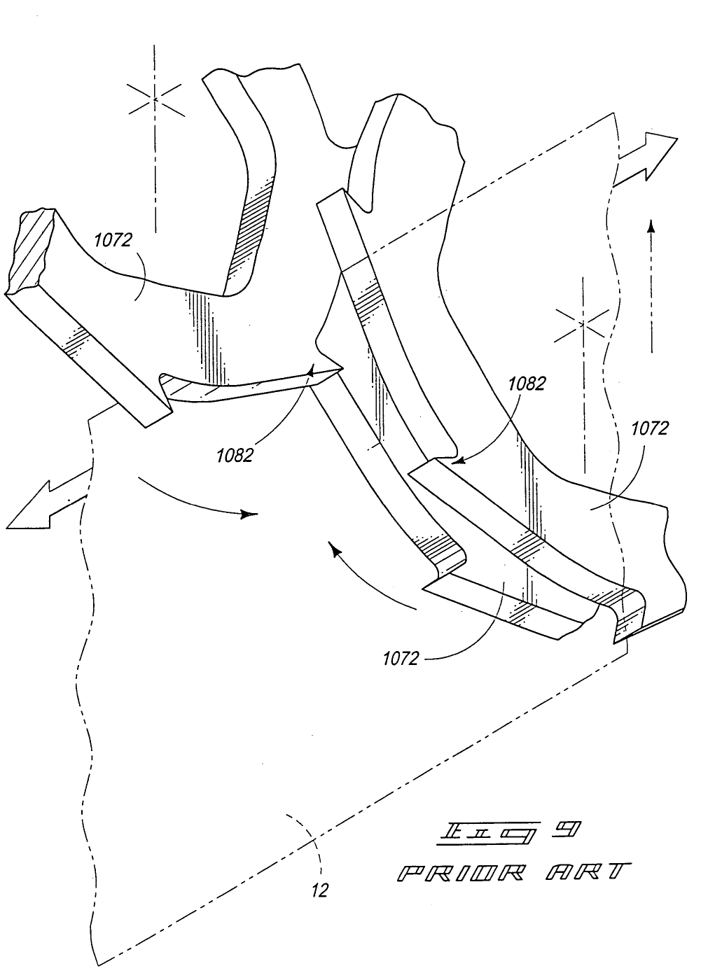

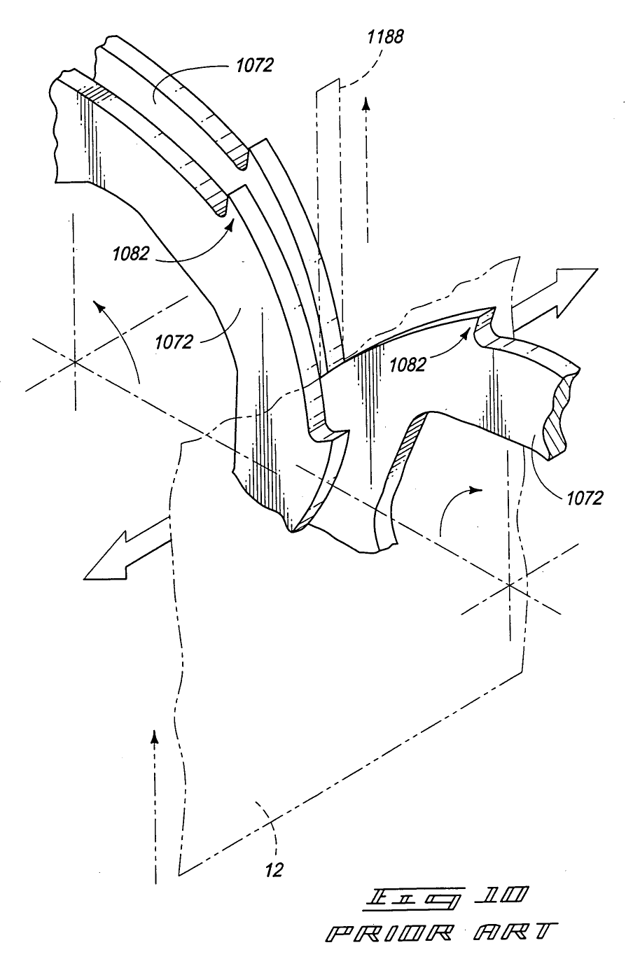

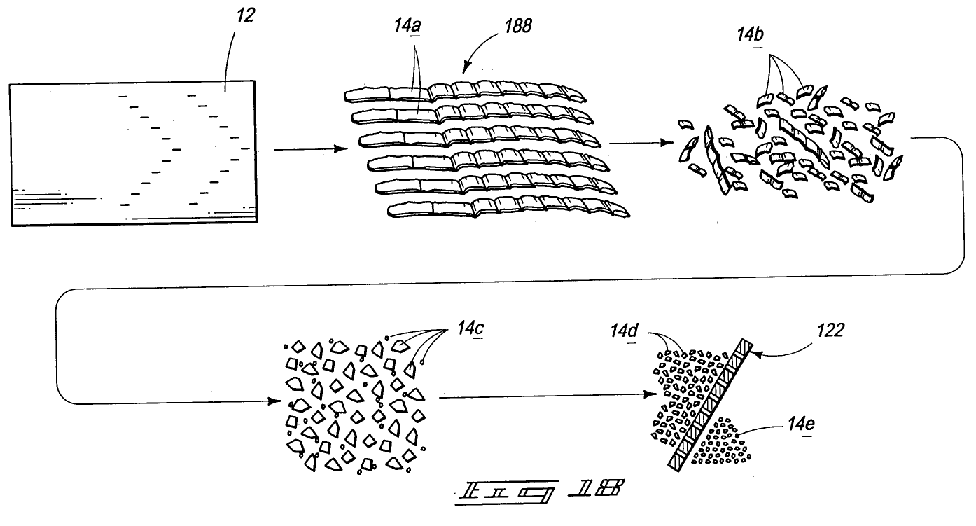

A preferred embodiment of the present invention is implemented via a waste comminuting apparatus generally designated with the reference numeral 10 in FIGS. 1-5 for receiving solid waste material 12 and for reducing the solid waste material progressively into smaller and smaller sizes until a desired small particulate or piece size is obtained, as illustrated in FIG. 18. More particularly, scissor rolls 46 and 48 (see FIG. 6) are each constructed using a plurality of serrated scissor rings 72 (see FIG. 7) that improve performance over prior art scissor rings under certain operating conditions and for selected materials. Rolls 46 and 48 are provided in a present-day version of a stand-alone Model CLS CHESAW® plastic granulating machine, or comminuting apparatus. An earlier version of the CLS CHESAW® comminuting apparatus is disclosed in U.S. Pat. No. 5,893,523, previously incorporated herein by reference, and using prior art scissor rings 1082 (see FIGS. 8-10). FIGS. 1-5 illustrate a new and upgraded version of the Model CLS CHESAW® comminuting apparatus that incorporates the newly designed scissor rolls, scissor rings, and separator screen of the present invention.

Comminuting apparatus 10 is relatively compact, and progressively reduces sheet 12 into pieces 14a through 14e in several stages to a desired predetermined small size, in a more efficient manner than prior art constructions. It is understood that the predetermined small piece size generally depends upon the desires of a particular customer, an end user, and a particular material being comminuted. For example, solid waste material 12, illustrated in FIG. 18, is progressively reduced to subdivided pieces 14a through 14e. When the subdivided pieces are generally reduced to the desired small size, 14e, they are removed from the comminuting apparatus as a final product. Subdivided pieces that have not been sufficiently reduced to the desired small size are reprocessed, or recycled, through the comminuting apparatus until they are sufficiently reduced to the desired size. Design improvements to the Model CLS CHESAW® comminuting apparatus presented herein significantly reduce the time needed to sufficiently reduce the subdivided pieces to the desired small size over the device taught in U.S. Pat. No. 5,893,523 which uses the prior art scissor rings 1072 shown in FIGS. 8-12.

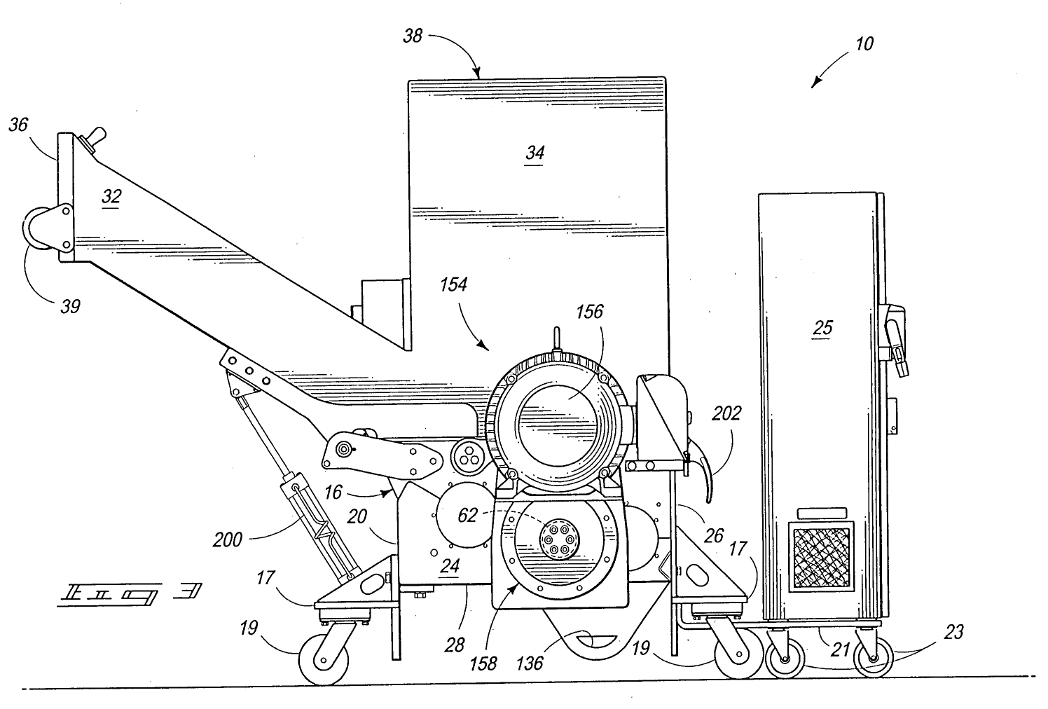

As shown in FIGS. 1-5, apparatus 10 has a general frame 16 that may be self-supported or affixed to other apparatus, such as a discharge of a thermoforming machine, for receiving solid waste material 12 directly from a thermoforming machine and reducing the sheet and pieces of material to the desired small size for reuse. Frame 16 generally includes an enclosure, or housing, 18. Enclosure 18 includes a front wall 20, side walls 22 and 24, a back wall 26, a bottom wall 28, and a top wall 30. An adjustable assembly comprising a first material receiving duct 32 and a second material receiving duct 34 are supported atop top wall 30 for pivotal positioning into a desired orientation and held in place using an air cylinder 200 and a cam lock assembly 202 (see FIG. 3). Material receiving duct 32 has a material entrance 36, whereas material receiving duct 34 has a material entrance 38, respectively (see FIGS. 1-4), through which the solid waste material is fed into apparatus 10. According to one construction, frame 16 is supported on legs 17 that each have individual pairs of wheels 19 at each corner of frame 16. Frame 16 preferably includes walls 20, 22, 24, 26, 28 and 30, as well as upper frame cross-members 40, 42, and lower frame cross-member 44, as illustrated variously in FIGS. 1-5.

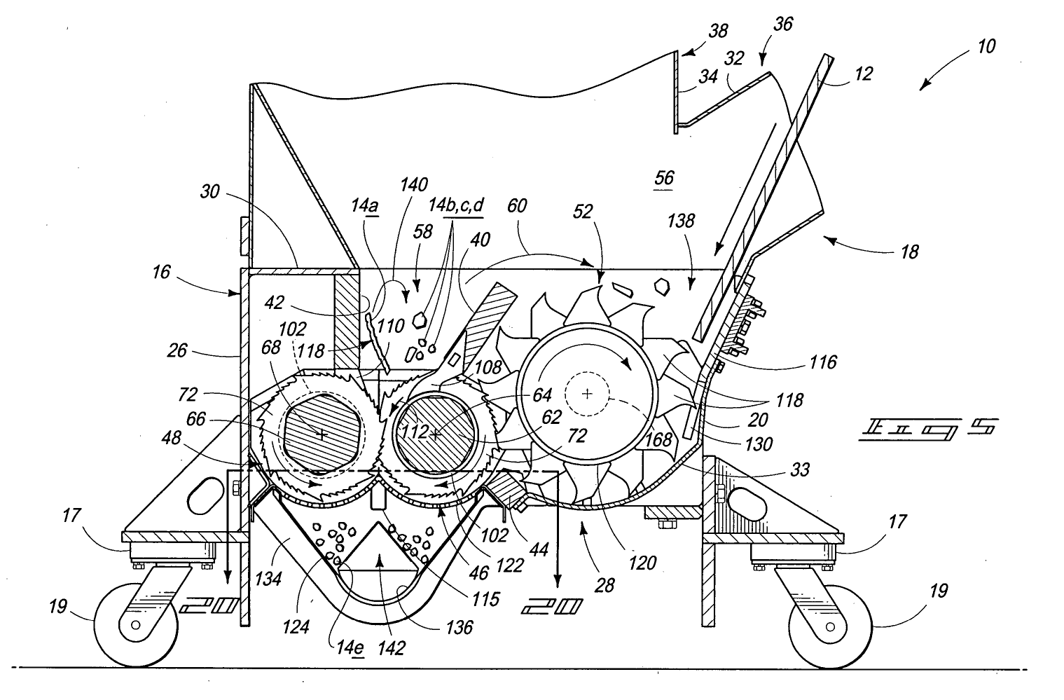

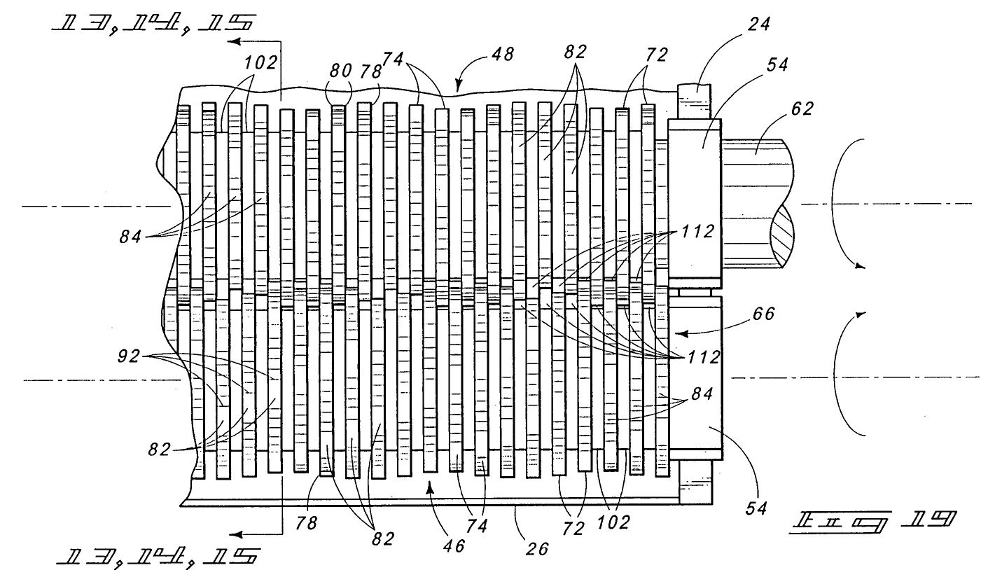

According to the implementation depicted in FIGS. 1-5, comminuting apparatus 10 incorporates a newly designed scissor ring 72 having serrated edges and provided within a pair of intermeshing scissor rolls 46 and 48. Rolls 46 and 48 are driven to rotate in opposite directions relative to one another and receive solid waste material 12 that is delivered therebetween via a feed roll 52. The solid waste material 12 is sheared in a more efficient manner using scissor rings 72 than when using prior art scissor ring constructions (such as scissor rings 1072 of FIGS. 8-10), as the material passes up between scissor rolls 46 and 48 (see FIG. 5). Feed roll 52 is supported at each end by a bearing similar to bearing 54 of FIG. 19.

Scissor rolls 46 and 48 are positioned within enclosure 18, between an intake manifold 56 that receives the material through material entrance 36 and/or entrance 38 and an outtake manifold 142. After the material passes up between scissor rolls 46 and 48 from beneath, the sheared material ascends into a recycle manifold 58 (see FIG. 5) that communicates with intake manifold 56 via a recycle flow path 60.

As shown in FIG. 5, scissor roll 46 includes a plurality of scissor rings 72 mounted in spaced-apart relation on a shaft 62 that rotates about an axis 64. A ring spacer 102 is provided between each adjacent scissor ring 72 on scissor roll 46. Likewise, scissor roll 48 includes a plurality of scissor rings 72 and ring spacers 102 that are configured to intermesh with the scissor rings 72 on scissor roll 46.

Scissor roll 48 is mounted on a shaft 66 that rotates about an axis 68. Axes 64 and 68 are parallel with each other, both in a horizontal plane, and extend between side walls 22 and 24. Axes 64 and 68 are positioned so that scissor rolls 46 and 48 have sufficient overlap to shear the material between the scissor rolls as the material passes up between the scissor rolls. Shafts 62 and 66 are supported for rotation at each end by respective bearings 54 (see FIG. 19). Each of shafts 62 and 66 has a hexagonal cross-sectional profile, thereby providing angular drive surfaces 70 (see FIG. 7).

Through experimental and prototype testing, it has been discovered that a significant increase in processing capacity is imparted to scissor rolls 46 and 48 by using a newly designed, serrated edge scissor ring 72, as shown in FIGS. 5-7. Scissor ring 72 replaces the prior art construction of scissor rings 1072, depicted in FIGS. 8-10. It presently appears that the serrated edge construction on scissor ring 72 significantly improves the rate and quantity of waste material that can be processed between scissor rolls 46 and 48, irrespective of the particular construction of the comminuting apparatus.

As shown in FIGS. 1-5, scissor rings 72 have been incorporated into a modified CHESAW® Model CLS comminuting apparatus from Irwin Research and Development, Inc., of Yakima, Wash. However, scissor ring 72 can be incorporated into any comminuting apparatus having two or more scissor rolls that cooperate to subdivide solid waste material. It is further understood that scissor rolls 46 and 48 do not necessarily have to be in a horizontal plane, nor do they have to be fed with waste material from below. Alternatively, scissor rolls 46 and 48 can be inclined in the plane of their central axes, and waste material can be fed from above and in between the scissor rolls as they rotate in an opposite direction from that depicted in FIG. 5. It is further understood that it is not necessary to use a feed roll in order to benefit from the improvements provided by the incorporation of scissor ring 72 into one or more scissor rolls of a comminuting apparatus.

As shown in FIGS. 6 and 7, each of scissor rolls 46 and 48 includes a plurality of scissor rings 72, with each ring 72 having an outer peripheral surface 74 that is defined about a cylindrical geometry to provide a serrated pair of outer peripheral edges. Each scissor ring 72 also includes an inner hexagonal bearing surface 76 that mates in complementary relation with a profile on shafts 62 and 64 so that each scissor ring 72 rotates in response to rotation of shafts 62 and 64, respectively (see FIGS. 6 and 7). Each scissor ring 72 is aligned with a complementary ring spacer 102 on the opposite scissor roll so that adjacent scissor rings on opposite scissor rolls overlap to provide gripping, puncturing, and scissoring action against solid material that is received therebetween.

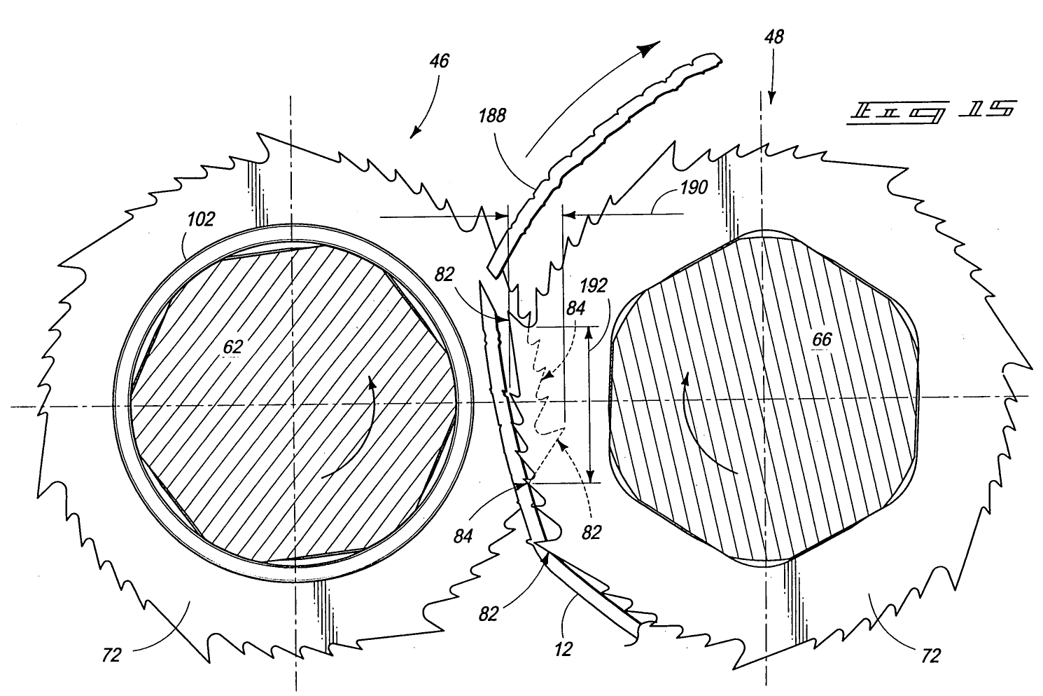

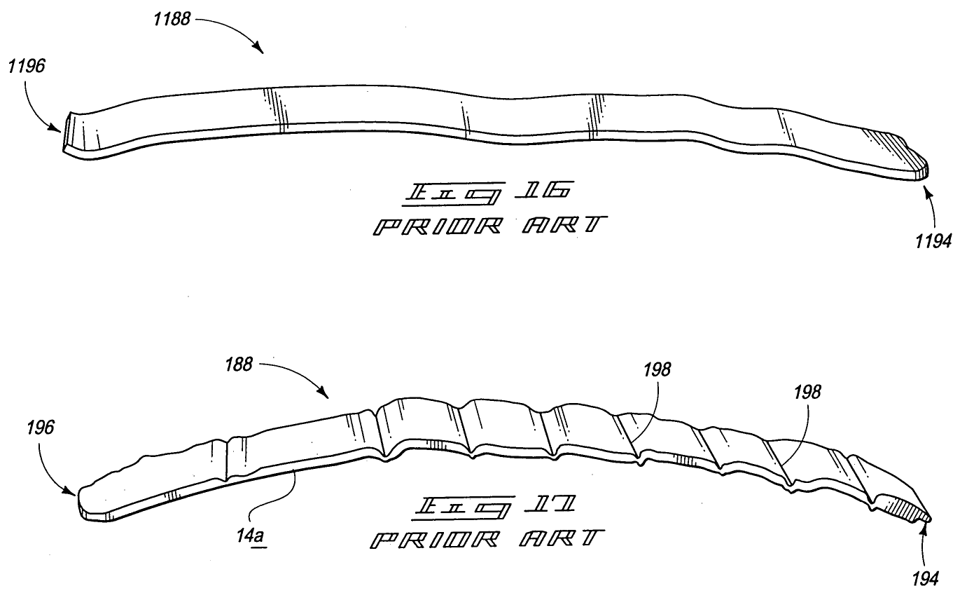

In operation, serrated outer peripheral surface 74 on scissor ring 72 imparts a unique combination of gripping, puncturing, and scissoring that generates a uniquely shaped cuttage piece, or strip, 188. Strip 188 is crinkled in contrast with relatively smooth strips 1188 (see FIG. 16) that are generated when using the prior art scissor rings of FIGS. 8-10. The crinkled shape of strips 188 (see FIG. 17) is presently believed to contribute to a significant increase in the production rate of a comminuting apparatus and it is presently believed that fewer passes are needed through the comminuting apparatus and between the scissor rolls 46 and 48 in order to realize a final, predetermined small piece size. Accordingly, production capacity for a comminuting apparatus is significantly improved when incorporating the scissor ring 72 of the present design into a comminuting apparatus.

As shown in FIG. 6, scissor rolls 46 and 48 are supported at opposite ends by bearing assemblies 54 which are respectively supported within side walls 22 and 24 (see FIGS. 1-5). Rolls 46 and 48 are driven in counter-rotation such that an entrance nip is provided between scissor rolls 46 and 48 from below.

As shown in FIG. 5, waste material 12 is drawn in and punctured by fingers 118, wherein fingers 118 extend from the outer periphery of a drum 120 on feed roll 52. Fingers 118 pull sheet 12 down along sheet metal tray 33, along lower frame cross-member 44 (which has metering fingers interspaced therebetween) and between roll 46 and a perforated plate separator screen 122. Sheet 12 then passes up between scissor rolls 46 and 48 for subdividing therebetween via intermeshing co-action of scissor rings 72.

According to the present construction, each of scissor rings 72 has evenly angularly spaced large finger knives 82 as well as small finger knives 84, as shown in FIGS. 11-15. Each of scissor rings 72 includes a pair of parallel side surfaces 78 that form shearing edges 80 with the outer peripheral surface 74. The co-action of intermeshing, adjacent scissor rings 72 causes the serrated shearing edges 80 to co-act with adjacent serrated shearing edges 80 on adjacent, intermeshing scissor rings 72 to sever a strip. The large finger knives 82 completely sever an end of the strip of material when they are moved closest to and opposite ring spacer 102 that is provided between adjacent, opposite scissor rings 72. Crinkling occurs to the strip as small finger knives 84 come together to co-act and crinkle the web of waste material as that portion of the serrated shearing edges 80 co-acts along the smaller finger knives 84. Such crinkling of a strip 188 (see FIG. 17) of waste material is presently believed to greatly increase the production capacity of a comminuting apparatus.

As shown in FIG. 19, side surfaces 78 on adjacent, intermeshing scissor rings 72 interact with each respective outer peripheral surface 74 to provide a shearing edge 80. Shearing edge 80 includes the edges provided by finger knives 82 and 84. However, shearing is somewhat interrupted by the interaction of finger knives 82 and 84 which contribute additionally to tearing and crinkling of a strip of sheet material during co-action of such shearing edges 80 between adjacent, intermeshing scissor rings 72. As shown in FIGS. 11-15, each of scissor rings 72 has a first set of even, angularly spaced and relatively large finger knives 82 formed on scissor ring 72 and projecting radially outward of surface 74 and formed in the direction of rotation for gripping, puncturing, and transversely cutting solid material 12, as illustrated in FIGS. 11-15. Furthermore, each scissor ring 72 includes a plurality of even and angularly spaced relatively small finger knives 84 provided in groups between adjacent finger knives 82 and formed integrally on scissor ring 72. Finger knives 84 also project radially outward of surface 74, but to a lesser extent than finger knives 82, and forward in the direction of rotation for crinkling and severing the solid material 12, as illustrated in FIGS. 11-15. According to one construction, there are seven relatively large finger knives 82 and thirty-five relatively small finger knives 84 on each scissor ring 72.

As shown in FIG. 1.3, each of relatively large finger knives 82 includes a projecting body 86 that projects radially outward from outer peripheral surface 74 and projects forward in the direction of rotation. Each of finger knives 82 includes a side shearing surface 88 and an undercut surface (or gullet) 90, forming a sharp knife point 92. Relatively large scissor ring finger knives 82 are configured to grip, puncture and transverse the cuttage piece of waste material 12 as it is being sheared between adjacent, intermeshing scissor rings 72.

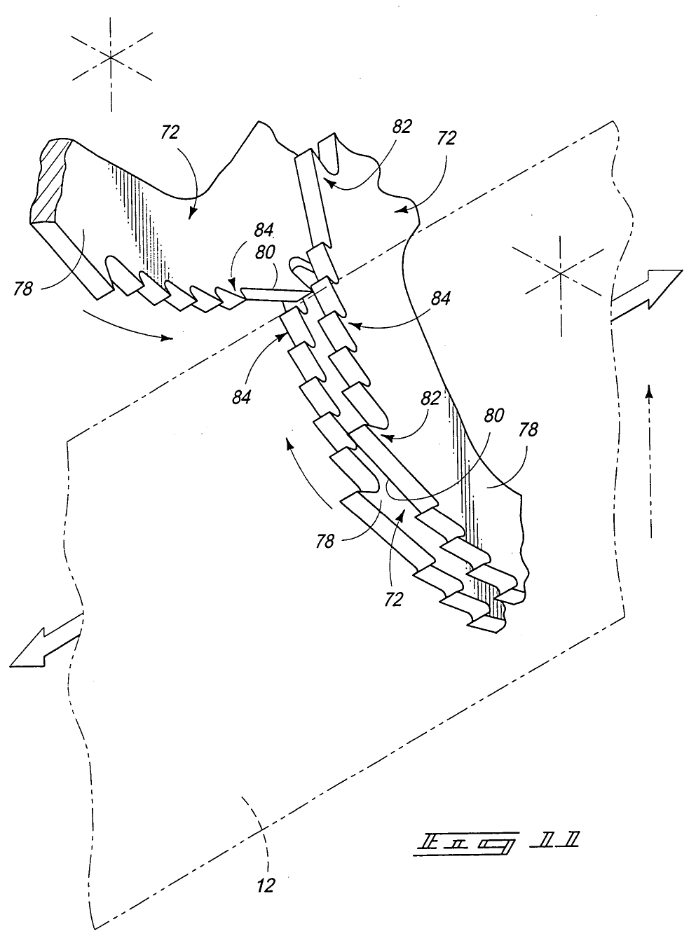

Likewise, each of finger knives 84, although smaller than finger knives 82, includes a projecting body 94 that projects radially outward from the outer peripheral surface 74 and projects forward in the direction of rotation of scissor ring 72. Each finger knife 84 includes a side shearing surface 96 and an undercut surface (or gullet) 98, forming a sharp knife point 100. The relatively smaller finger knives 84 cooperate with adjacent finger knives such that the respective shearing edges 80 (see FIGS. 11 and 12) cause a cuttage piece of waste material to be crinkled, torn and severed between such respective shearing edges 80, in part due to the projections of finger knives 84.

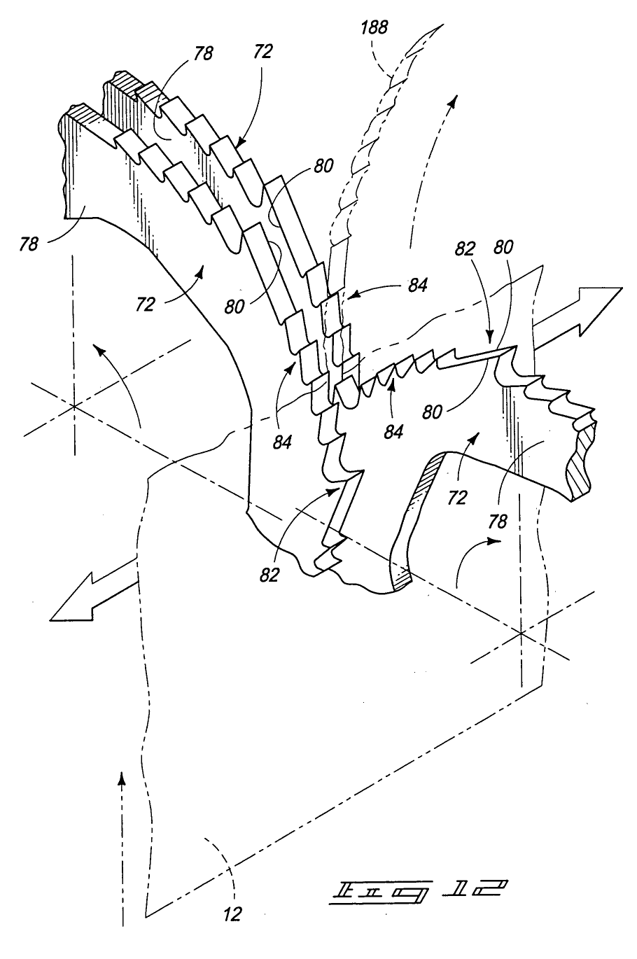

It is presently believed that finger knives 84 cause crinkling of waste material during scissoring between adjacent scissor rings 72 because the penetration (or overlap) depth 190 (see FIG. 13) of the respective shearing edges 80 is substantially less when finger knives 84 are interacting with the piece of material, in contrast to finger knives 82 which are substantially larger and which tend to interact with an adjacent shearing edge 80 so as to completely sever an end of strip 188 (see FIGS. 13-15) from sheet of material 12.

As shown in FIG. 7, scissor roll 46 (as well as scissor roll 48 of FIG. 6) includes a plurality of ring spacers 102 positioned between each adjacent scissor ring 72. Ring spacer 102 has a circular outer peripheral surface 104 and a cylindrical inner peripheral surface 106. Surface 106 is sized to fit about the corners of the angular drive surface 70 that provides an outer hexagonal bearing surface on each shaft 62 and 66 (see FIG. 6). Each ring spacer 102 is sized to have a thickness that is essentially the same thickness of a respective scissor ring 72.

As shown in FIGS. 7 and 11-15, each scissor roll 46 and 48 further includes a plurality of ring spacers 102. Each ring spacer 102 has a circular outer peripheral surface 104 and a circular inner peripheral surface 106 sized relative to surface 70 on shaft 62 (and shaft 66) so that ring spacer 102 fits snugly onto the respective shaft, but is free to rotate thereabout. In operation, scraping (or stripping) fingers 108 and 110 ride along each ring spacer 102, along each of scissor rolls 46 and 48, respectively, as shown in FIG. 5. Stripper fingers 108 and 110 cooperate with a respective ring spacer to remove subdivided waste material from between adjacent scissor rings 72.

As shown in FIG. 7, one suitable construction for ring spacer 102 has an outer diameter of 5.25 inches, an inner diameter of 4.75 inches, and a thickness of 0.3754 inches. Additionally, scissor ring 72 has an outer diameter, defined by the radial outermost point of the large finger knives, of 7.946 inches and a thickness of 0.3754 inches. The controlled width of ring spacer 102 and scissor ring 72 is accomplished by double disc grinding the respective hardened steel parts.

As shown in FIG. 5, a plurality of scraper fingers 108 are supported in side-by-side relation via cross-member 40 so that a single scraper finger 108 engages along an outer surface of each ring spacer 102, between adjacent pairs of scissor rings 72 on scissor roll 46. Likewise, a plurality of scraper fingers 110 are carried by cross-member 42, with a single scraper finger 110 dedicated to scrape or follow an outer surface of a respective ring spacer 102 on scissor roll 48. Accordingly, ring spacers 102 are alternately positioned on shafts 62 and 66 so that a scissor ring 72 on one scissor roll opposes a corresponding ring spacer 102 on the other scissor roll, creating a circular inter-roll cavity 112 (see FIG. 19) between the adjacent rings and outward of the intermediate ring spacers 102. Once the material 12 is cut and sheared, it is received in the inter-roll cavity 112 (see FIG. 19) and passes between rolls 46 and 48 into the recycle manifold 58.

As shown in FIGS. 5 and 13, axes 64 and 66 of scissor rolls 46 and 48 are sufficiently spaced apart so that there is a slight overlap of approximately one-eighth inch (⅛″) in the profile of the scissor rings when the radial innermost outer peripheral surface 74, provided by an innermost portion of gullet 98 of smaller finger knife 84 is rotated closest to an adjacent scissor ring 72. Accordingly, as scissor rings 72 are rotated, the material is sheared by the shearing edges 80 and the finger knives 82 and 84 as a profile of the scissor rings 72 moves into the circular inter-roll cavity 112 of the opposing ring spacer 102 (see FIG. 13).

As shown in FIG. 11, relatively large finger knives 82 tend to grab and puncture a leading edge of sheet of material 12 which is pulled upwardly between adjacent, intermeshing scissor rings 72. Shearing edge 80 extends about the entire periphery of each scissor ring 72, including surfaces defined by the edges of finger knives 82 and 84. However, finger knives 82 and 84 tend to also impart tearing and cutting of sheet of material 12 as sheet of material 12 is driven between an intermeshing set of adjacent scissor rings 72, as depicted in FIG. 11. Relatively large finger knives 82 pull sheet 12 upward between three adjacent, interacting and intermeshing scissor rings 72, after which relatively smaller finger knives 84 crinkle (or fold) a respective strip 188 (see FIG. 12) which is severed along side edges from sheet of material 12 by co-action of shearing edges 80 between adjacent, intermeshing scissor rings' 72, as depicted in FIG. 12. Relatively smaller finger knives 84 tend to crinkle strip 188 as sheet 12 is passed therebetween. Concurreritly or subsequently, shearing edges 80 co-act along large finger knives 82 to sever an end of strip 188 from sheet 12, resulting in the severed strip 188 depicted in FIG. 12.

Relatively small finger knives 84 co-act to crinkle strip 188, whereas relatively large finger knives 82 tend to generate sufficient transverse stresses (or shear stresses) so as to terminate or cut an end portion of strip 188 as such relatively large knife 82 draws in closest proximity to the opposed ring spacer 102 (see FIG. 13). It is presently believed that subdivided pieces of material that have been recirculated around and between the pair of scissor rolls also cooperate with sheet 12 to encourage severing of strip 188 as relatively large finger knife 82 is drawn in closest proximity with ring spacer 102. It is understood that such additional recycled, subdivided material is passed therebetween for further subdividing, and as such material passes in inter-roll cavity 112, additional stresses and compaction further contribute to severing of the end of strip 188 from sheet 12.

FIG. 13 illustrates the passage of a sheet 12 of waste material that has been delivered via a feed roll around and beneath roll 46 and up and between feed rolls 46 and 48 for subdividing therebetween.

FIGS. 13-15 illustrate the progressive advancement of sheet of material 12 up between a pair of co-acting and counter-rotating scissor rings 72 on rolls 46 and 48. It is understood that three adjacent scissor rings 72 must co-act in order to sever a strip 188, as previously depicted with reference to FIGS. 11 and 12. In order to simplify the drawings, remaining portions, including a separator screen, have been removed from FIGS. 13-15.

FIG. 13 illustrates sheet 12 being fed up between three intermeshing scissor rings 72 (with the left closest scissor ring 72 removed from shaft 62). A crinkled strip 188 has just been severed from sheet 12 and sheet 12 is being advanced upwardly by a relatively large finger knife 82 that is engaging upwardly and toward an opposed ring spacer 102, thereby pulling sheet 12 upwardly toward inter-roll cavity 112.

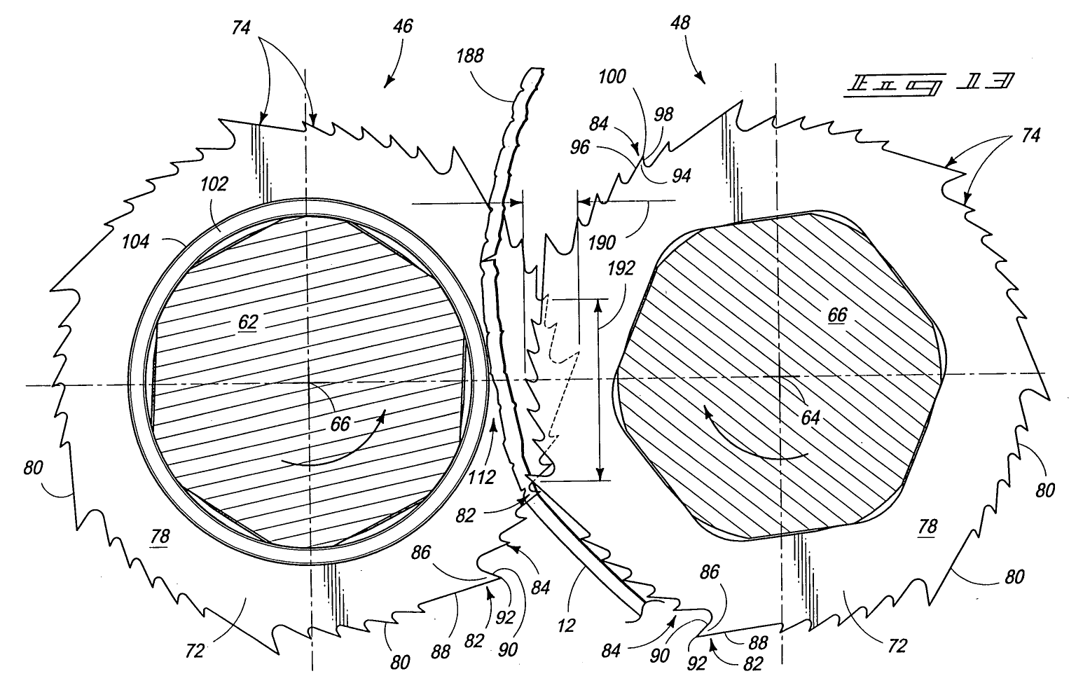

FIG. 14 illustrates the advancement of the relatively large finger knife 82 at a maximally close position alongside opposed ring spacer 102 at a location that typically coincides with severing of strip 188 from sheet 12. It is understood that crinkling of strip 188 happens prior to relatively large finger knife 82 reaching the position depicted in FIG. 14. More particularly, as relatively small finger knives 84 on scissor rings 72 of shaft 66 converge with the shearing edge 80 of the adjacent, opposed scissor rings 72 on shaft 62, sheet 12 is crinkled, as well as severed, by the adjacent co-acting shearing edges 80. As the next relatively large finger knife 82 on scissor ring 72 of shaft 66 moves to the next closest proximity with opposed ring spacer 102 on shaft 62, a new strip is then severed at a trailing end.

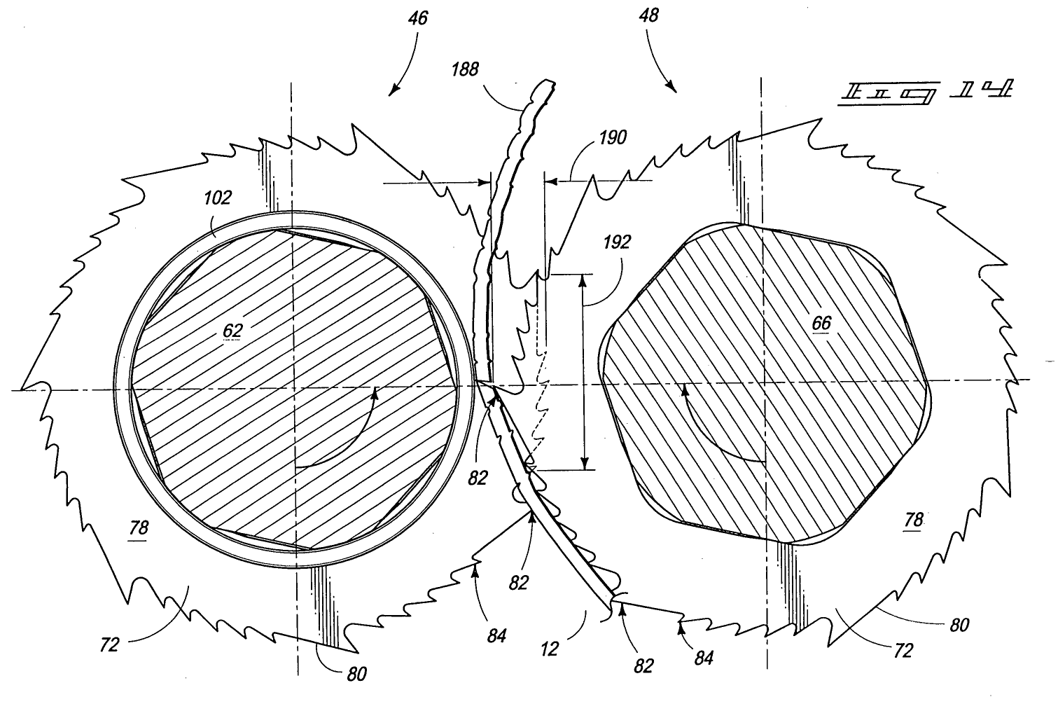

FIG. 15 illustrates advancement of a strip 188 subsequent in time to that depicted in FIG. 14 where severed strip 188 is subsequently cleared and moved for further recirculation between rolls 46 and 48 and for further subdividing therebetween. Relatively small finger knives 84 on scissor ring 72 of shaft 66 cooperate to form folds, creases or crinkles in the next upcoming segment of sheet 12 that will produce a new, subsequent strip once the next relatively large finger knife 82 moves to a closest proximity position alongside opposed ring spacer 102. The co-action of the shearing edges along relatively small finger knives 84 of scissor ring 72 on shaft 66 with the shearing edge on opposed and adjacent scissor rings 72 on shaft 62 causes crinkling and edge severing of a strip from sheet 12. Co-action of relatively large finger knives 82 on scissor ring 72 of shaft 66 with shearing edges of adjacent co-acting scissor ring 72 on shaft 62 causes end and edge severing of the strip from sheet 12 as finger knife 82 on scissor ring 72 on shaft 66 moves to a closest proximity position alongside opposed ring spacer 102 on shaft 62. It is understood that the scissor ring 72 cuts a strip from sheet of material 12 by interacting with the shearing edge of adjacent, opposite scissor rings along shafts 62 and 66.

As shown in FIG. 5, once material 12 is cut and sheared by feed roll 52 and scissor rolls 46 and 48, material 12 is carried into recycle manifold 58, which communicates with, and is formed in part by, intake manifold 56. Once cut and sheared material 12 collects sufficiently high in recycle manifold 58, material 12 cascades over the top portion of frame cross-member 40, falling onto the top of feed roll 52, where the material is recycled via recycle flow path 60 for further subdividing and/or sorting. In this manner, cut and sheared material, in the form of crinkled strips and subdivided pieces, is again fed via feed roll 52 back up beneath and between scissor rolls 46 and 48. More particularly, the material is passed between feed roll 52 and a feed plate 116, as well as between feed roll 52 and a sheet metal tray 33. Individual teeth, or fingers, 118 along drum 120 of roll 52 convey and deliver sheet of material 12, along with recirculated cut and sheared material, back to roll 46 for further delivery, sorting and/or severing.

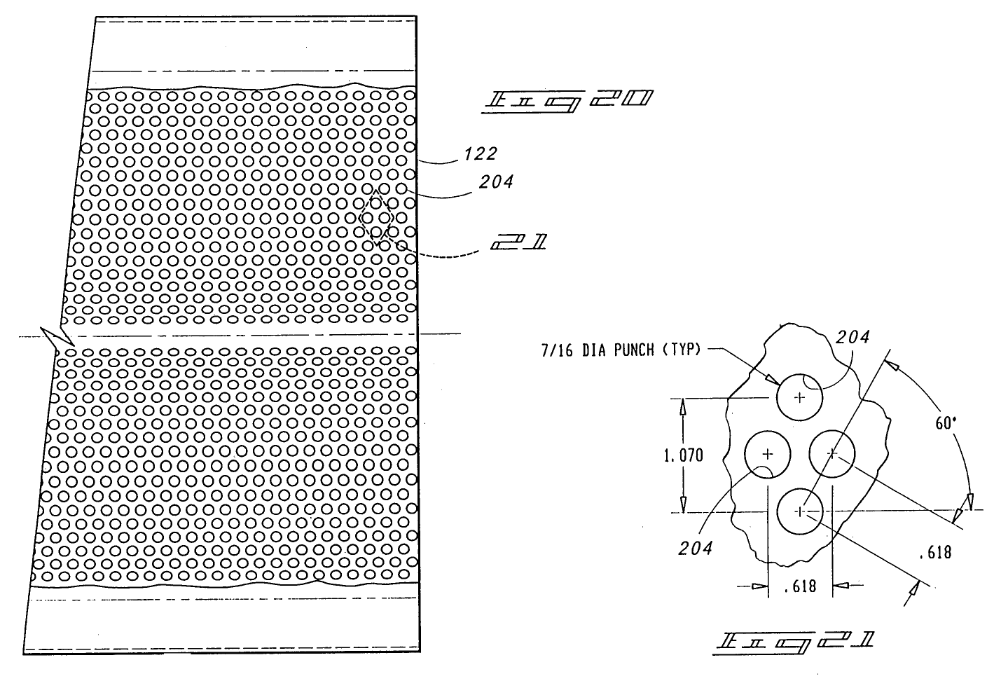

Accordingly, material 12 is cut into crinkled strips 188 (see FIGS. 13-15 and 17) during a first pass between scissor rolls 46 and 48, as shown in FIG. 5. Material 12 which passes over flow path 60 and is directed to feed roll 52 is thus recirculated via fingers 118 and feed plate 116 back to scissor roll 46, where material 12 is reprocessed between rolls 46 and 48 for delivery back into recycle manifold 58. Particle's 14e of sufficiently small size are separated out via a perforated plate, or separator screen, 122 which is provided immediately below and adjacent to rolls 46 and 48. Separator screen 122 generally conforms to a general nested bottom surface configuration of rolls 46 and 48. As shown in FIG. 5, perforated plate 122 has the shape of a biconcave perforated plate. Apertures 204 (see FIGS. 20 and 21) in plate 122 are sized such that sufficiently small particles 14e drop through the apertures in plate 122 where they are collected via a collection tray 124.

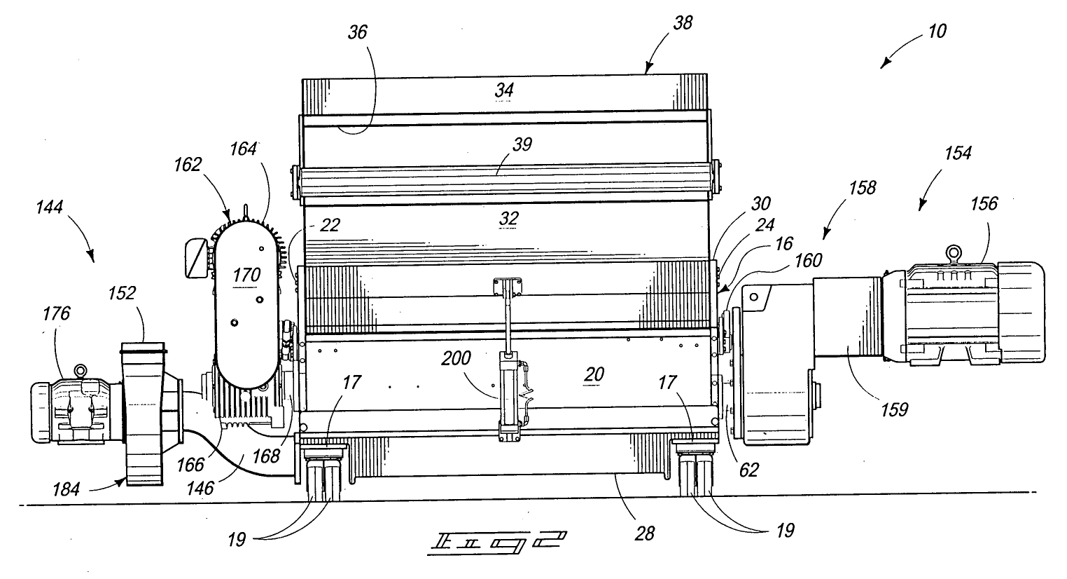

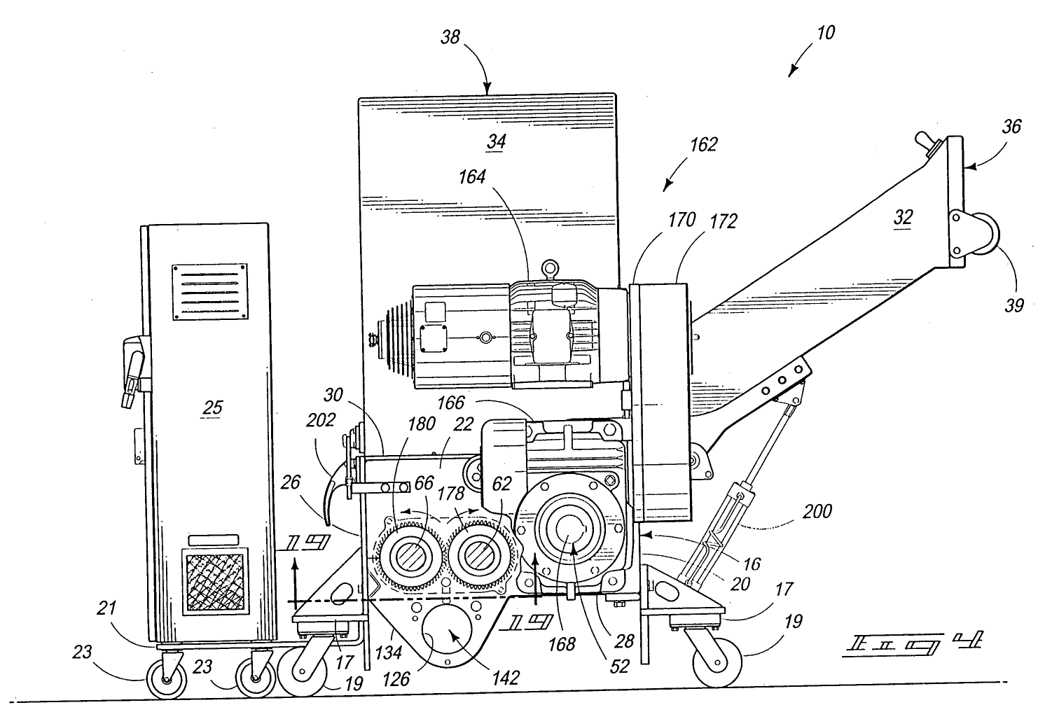

As shown in FIG. 5, screen 122 comprises a perforated plate that is held at either end by a mounting bracket assembly, such as a U-shaped channel piece 115 provided at one end of screen 122, along a central portion. Accordingly, screen 122 is provided in close communication with each of rolls 46 and 48 along an entrance nip provided below and therebetween. Collected particles 14e, present within tray 124, are then withdrawn through an outlet 126 (see FIG. 4) by way of a pneumatic conveyor 144 (see FIGS. 1 and 2). An air vent 136 is provided opposite outlet 126, as shown in FIGS. 3 and 5, in order to ventilate outlet 126 when removing particles 14e. Articles 14a-d which are not sufficiently small enough to pass through apertures in screen 122 continue to be recirculated between rolls 46 and 48 via feed roll 52.

In addition, it has been discovered that some of recirculated pieces 14a-14e in recycle manifold 58 are sifted, or passed, in a reverse direction along flow path 140 where they fall backwards, or in reverse, between inter-roll cavities 112 (see FIG. 5) and return to screen 122. Accordingly, particles which have sufficiently small size 14e are sifted by falling back via flow path 140 to screen 122 where they are collected in tray 124. Likewise, particles that fall back that are not sufficiently small in size, such as particles 14a-14b, are passed down through rolls 46 and 48 where they are reprocessed and delivered upwardly for further recycling between rolls 46 and 48 to recycle via manifold 58, flow path 60 and intake manifold section 138.

As shown in FIG. 5, plate 116 includes a plurality of finger slots 130 sized to accommodate passage of fingers 118 on feed roll 52. Feed plate 116 is fastened to sheet metal tray 33. A portion of tray 33 and feed plate 116 cooperate to provide a portion of front wall 20, while tray 33 also cooperates to provide a portion of bottom wall 28.

Accordingly, feed plate 116 of FIG. 5 includes a plurality of slots 130, each configured to provide clearance for a respective finger 118 on feed roll 52. Preferably, there is a relatively narrow clearance between each finger 118 and each slot 130. As also shown in FIG. 5, intake manifold 56 includes intake manifold section 138. New solid waste material 12 enters through one of material entrances 36 and 38 via an associated material receiving duct 32 and 34 (see FIGS. 1-4) and subdivided material requiring additional recycling is recirculated back into recycle manifold section 58 where it is redelivered by way of recycle flow path 60, or it is alternatively returned via reverse sort path 140 for sifting in screen 122 or further severing and subdividing between rolls 46 and 48. As shown in FIG. 5, outtake manifold 142 includes an outlet 126 (see FIG. 4) and a collection tray 124 with a pneumatic conveyor 144 facilitating the removal of the smaller-sized severed pieces 14e from the outtake manifold 142 and to entrain such pieces 14e in an airstream via an outtake pipe 146 (see FIGS. 1 and 2) and pneumatic conveyor 144. Outtake pipe 146 provides an airstream conduit for directing an airstream with entrained subdivided pieces from the shear outtake manifold 142 to an outer volute duct along a flow path within pneumatic conveyor 144 to a product outlet 152 (see FIG. 1). Outtake pipe 146 provides an airstream conduit for directing an airstream with entrained subdivided pieces from the shear outtake manifold An air vent 136 is provided in an end wall 134 which ventilates outtake manifold 142 when pneumatic conveyor 144 draws air via outtake pipe through outlet 126 (see FIG. 4).

Apparatus 10 includes a scissor roll drive 154, as shown in FIGS. 1-4. Scissor roll drive 154 includes a motor 156 connected to a speed reduction gear box 158. Speed reduction gear box 158 is operatively connected to shaft 62 for rotating, or driving, shafts 62 and 64 counter to each other in the directions illustrated in FIGS. 4-6. Shafts 62 and 66 are geared together for counter rotation via intermeshing gears 178 and 180, respectively, as shown in FIG. 4. Speed reduction gear box 158 includes a coupling assembly 159 that enables attachment of motor 156 onto speed reduction gear box 158.

According to one construction, motor 156 comprises a Baldor 30 hp AC motor, Part No. CM4104T, sold by Baldor Electric Company, of Fort Smith, Ariz. Also according to one construction, gear box 158 comprises a Nord drive, Model No. SK6282AZ-280TCx2.938-12.35, sold by Nord Gear Corporation, of Waunakee, Wis. Speed reduction gear box 158 enables motor 156 to drive shaft 62, as shown in FIGS. 1-4. Motor 156 is supported by gear box 158 via a mounting strut 160 which forms framework for fixing gear box 158 onto frame 16.

Apparatus 10 also includes a feed roll drive 162 illustrated in FIGS. 1-4. Feed roll drive 162 includes a motor 164 connected to a speed reduction gear box 166. Gear box 166 is operatively connected to a shaft 168 (see FIG. 4) along one end of feed roll 52 (see FIGS. 1 and 5). Accordingly, gear box 166 operatively connects shaft 168 with motor 164 for rotating feed roll 52 in the direction illustrated in FIG. 5. Motor 164 is carried by gear box 166 via a mounting bracket 170 (see FIGS. 1 and 2). Motor 164 is coupled to drive gear box 166 by way of a chain drive and a pair of sprockets contained within chain drive cover 172, along mounting bracket 170.

According to one construction, motor 164 is a Baldor Vector 10 hp AC variable speed motor, Model No. ZDM3774T, sold by Baldor Electric Company, of Fort Smith, Ariz. Also according to one construction, gear box 166 is a Cone Drive gearbox, or transmission, sold under the name Cone Drive®, by Cone Drive, of Trevor City, Mich.

Although motors 156 and 164 are provided as AC motors, an alternative construction utilizes an AC servo motor along with a servo drive motor controller.

By controlling the operating speed of motor 164, feed roll 52 can be rotated at a desired line speed for a material 12 being received within apparatus 10, as shown in FIG. 5. As shown in FIG. 5, material 12 can be received in the form of a web of material from a thermoforming press, wherein the material 12 is drawn in via feed roll 52 substantially at a line speed by actuating motor 164 (see FIG. 2) at an appropriate speed. Scissor roll 46 (as well as scissor roll 48) is driven by motor 156 at a set rotational speed. As shown in FIG. 5, scissor roll 48 is driven in a rotational direction opposite that of scissor roll 46. Gears 178 and 180 (see FIG. 4) are provided at the opposite end of drive 162 to drive scissor rolls 46 and 48 in co-rotation (opposite rotation, but jornalled together), which causes scissor rolls 46 and 48 to comminute material as it is drawn upwardly therebetween.

Pneumatic conveyor 144 of apparatus 10 conveys subdivided pieces 14 from outtake manifold 142 (see FIG. 5) via outtake pipe 146, as shown in FIG. 2. A product outlet 152 ejects the sufficiently small sized pieces 14e from outtake manifold 142 where the sufficiently small subdivided pieces 14e are collected in a storage vessel (not shown) for later recycling.

One suitable construction for pneumatic conveyor 144 comprises' a centrifugal fan, as depicted and disclosed in U.S. Pat. No. 5,893,523, previously incorporated by reference. According to one construction, motor 176 is a 7½ hp AC motor, Model No. CM3616T, sold by Baldor Electric Company, of Fort Smith, Ariz.

In operation, feed roll 52 of FIG. 5 moves material 12 towards feed plate 116 as fingers 118, having sharp forward-leading edges, engage the material 12, pulling material 12 between feed roll 52 and feed plate 116. The engaged material is then delivered by fingers 118 passing along slots 130 until it is brought into adjacent proximity with scissor roll 46. Scissor roll 46 then further engages material 12, causing some of material 12 to rip and sever, as roll 46 is preferably rotated at a higher speed than roll 52. Roll 46 then delivers or circulates material 12 along screen 122 and up between rolls 46 and 48 where material 12 is further engaged and severed.

As delivered material 12 engages between rolls 46 and 48, material 12 is gripped by the large and small finger knives, and pulled upwardly between scissor rolls 46 and 48, with scissor rings 72 and the accompanying shearing edges shearing and crinkling the solid waste material into crinkled subdivided pieces. The severed pieces 14a-14e then ascend into the recycle manifold section 58. The stripper fingers 108 and 110 strip any severed pieces from rolls 46 and 48, and remove them into the recycle manifold section 58.

After material 12 and subdivided pieces 14a-14e are delivered to scissor roll 46, scissor roll 46 in combination with scissor roll 48 further delivers the pieces along screen 122 where small subdivided pieces 14e are separated from the remaining material 12 and pieces 14a-14d. The subdivided pieces that are larger than the apertures or holes in the separator screen 122 are then carried along rolls 46 and 48 where they are delivered between rolls 46 and 48 for further severing and subdividing, or comminuting. The further subdivided pieces are then delivered into recycle manifold section 58. Such further subdivided pieces 14a-14e are then either redelivered via recycle flow path 60 onto feed roll 52 for further delivering and subdividing, or received in a reverse direction via reverse direction sort path 140 between rolls 46 and 48 and back along screen 122 where sufficiently small particles 14e are separated out through screen 122, and remaining portions are further subdivided between rolls 46 and 48. The small pieces 14e that pass through separator screen 122 are directed from apparatus 10 through product outlet 126 (see FIG. 4) to a pneumatic conveyor 144 (see FIG. 2) for delivery to final product outlet 152 (see FIG. 2).

The large particles or pieces 14a-14e will be continually recycled through the intake manifold section 138 or via reverse direction sort path 140 until their size is reduced below that of the pre-selected size of the apertures of the separator screen 122. Details of screen 122 are shown below with reference to FIGS. 20 and 21. Screen 122 can be replaced in order to provide apertures with the desired size for implementing a desired sort of particles. Screen 122 can be constructed from screen material or any suitable perforated sheet or plate, or other suitable construction.

Feed roll 52 is formed from a plurality of teeth or fingers 118 which are arrayed in two separate V-shaped patterns, as shown in FIGS. 1 and 5. Teeth 118 are formed from thin pieces of plate metal having a sharp leading edge, each piece being welded to the radial outermost portion of drum 120. In operation, a web of scrap material 12 leaves a trim press (not shown) of a thermoforming operation at a delivery, or line speed. Feed roll 52 is driven at a speed that is substantially the same as the line speed of the thermoforming line and trim press.

According to one construction, pneumatic conveyor 144 includes an AC motor 176 configured to drive a centrifugal fan 184 that is provided within a housing 186. Product outlet 152 is provided within housing 186.

FIG. 20 illustrates one suitable construction for a separator screen 122 formed from a sheet of steel and having a plurality of spaced-apart apertures, or holes, 204. FIG. 20 illustrates separator screen 122 with the scissor rolls moved from above in order to better view the placement and spacing of holes 204.

FIG. 21 illustrates one suitable geometry for the placement of holes 204 within the separator screen. FIG. 21 illustrates the placement of such holes 204 in essentially a plan view configuration. It is understood that the placement of holes 204 utilizes such spacing in each local region within the curved surfaces of the separator screen.

FIGS. 16 and 17 illustrate comparison drawings of actual strips produced by the present apparatus using prior art scissor rings of FIGS. 8-10 to create strips in FIG. 16, and the new scissor rings described herein and depicted in FIGS. 11-15 to create the crinkled strips in FIG. 17.

FIG. 16 illustrates such a prior art strip 1188 as produced by the scissor ring of FIG. 8. Strip 1188 has a leading end 1194 and a trailing end 1196. However, it has been found by experimental testing that strip 1188 is substantially planar and has only minor waves in the strip between leading end 1194 and trailing end 1196′.

In contrast, strip 188 of FIG. 17 is crinkled between a leading end 194 and a trailing end 196. A plurality of creases 198 are formed between leading end 194 and trailing end 196 that impart a three-dimensional shape to strip 188. It is presently believed that creases 198 are caused by the overlapping co-action of the relatively small finger knives within the overlap length 192 of FIG. 13. Creases 198 are believed to help increase the rate at which material is subdivided between serrated scissor rings.

According to an alternative construction, individual scissor rings 72 are coated along an entire outer peripheral surface 74 (see FIG. 7) with a coating that includes an admixture of a synthetic nano-diamond particulate and a thin dense chrome (TDC) coating. One suitable coating is commercially available from the Armoloy Corporation, of DeKalb, Ill., sold under the name XADC-Armoloy®. Armoloy Corporation applies this coating to customers' machine parts at their franchise location: Armoloy of Illinois, Inc., in DeKalb, Ill. The XADC coating has a surface hardness of 97 Rockwell (Rc) by adding synthetic nano-diamond particulates to an Armoloy thin dense coating (TDC) chemical bath. XADC coating has a coefficient of friction that is 20% lower than that of other Armoloy TDC coatings. According to such optional construction, such coating is applied to the entire outer peripheral surface 74, including along the side shearing surface, the sharp knife point, and the undercut surface (or gullet) for both the large finger knives and the small finger knives, as well as any remaining outer peripheral surface. Furthermore, such coating weeps over onto the sides of the scissor knife so as to coat each side of a scissor ring in the range of one to two millimeters along the radial outer side surface. For purposes of the experimental test results provided below, such optional coating was not tested.

Experimental Test Results

An experimental test was performed to compare production rates for the comminuting apparatus of the present invention, including the serrated scissor rings of FIGS. 11-15, as illustrated in the device of FIGS. 1-8 and 19-21, with the same comminuting apparatus, but having the prior art scissor rings depicted in FIGS. 8-10. FIG. 16 illustrates a drawing of an actual strip of waste material produced in a single pass between the scissor rolls when using the prior art scissor rings in the comminuting apparatus. FIG. 17 illustrates an actual crinkled strip of waste material produced by the apparatus of FIGS. 1-8 and 19-21 and using the serrated scissor rings of FIGS. 11-15. The strips of FIGS. 16 and 17 were formed when testing the comminuting apparatus using a 0.035-inch polystyrene foam sheet material.

Pursuant to the experimental test, an Irwin Research and Development, Inc. Model 50 CLS CHESAW® granulating machine (or comminuting apparatus) was configured with the prior art scissor rings of FIGS. 8-10 and a second Model 50 CLS granulating machine was configured with the serrated scissor rings of FIGS. 11-15. Both machines utilized the separator screen depicted in FIGS. 20-21. Both machines were run with a 145 revolutions per minute (RPM) scissor ring rotational speed. The drive motors for the pairs of scissor rolls were both 30 hp motors, the pneumatic conveyor used a 7½ hp blower motor, and a big-toothed feed roll was utilized along with a 7/16-inch diameter hole separator screen, as previously described with reference to FIGS. 20-21.

The test results for the Model 50 CLS with the prior art scissor rings and 0.035-inch thickness polystyrene foam (three layers thick) was 1,080 lbs/hour. The test results for the Model 50 CLS with the serrated scissor rings of the present invention was 0.035-inch thickness polystyrene foam (three layers) of 1,490 lbs/hour. Additionally, the machine with the prior art scissor rings and the 7/16-inch separator screen produced a material grind that was unacceptable in most customer applications. More particularly, the grind of the waste material comprised relatively long strips of subdivided material in the range of 3/4 inch to 1 1/2 inches, and also produced a much larger flake size of the waste material.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A rotating scissor ring, comprising:
a disk-shaped body having an outer peripheral surface;
a first set of first finger knives spaced apart about the outer peripheral surface; and
a second set of second finger knives subdivided into a plurality of groups of second finger knives, the second finger knives geometrically distinct from the first finger knives, and each group comprising a plurality of second finger knives provided between a pair of adjacent first finger knives.

2. The scissor ring of claim 1 wherein the disk-shaped body further comprises an inner drive surface.

3. The scissor ring of claim 2 wherein the inner drive surface comprises a hexagonal bearing surface configured to be received over a hexagonal drive shaft.

4. The scissor ring of claim 1 wherein the first set of first finger knives are spaced equidistant about the outer peripheral surface of the disk-shaped body.

5. The scissor ring of claim 1 wherein individual second finger knives within each group of second finger knives are spaced apart equidistant relative to one another in a group, and wherein the group of second finger knives is provided between a respective pair of adjacent first finger knives.

6. The scissor ring of claim 1 wherein the disk-shaped body has a pair of substantially parallel side surfaces.

7. The scissor ring of claim 6 wherein each side surface cooperates with the outer peripheral surface to form a shearing edge.

8. The scissor ring of claim 7 wherein each of the first finger knives and the second finger knives comprises a sharp knife point having an undercut surface and a pair of parallel side shearing surfaces communicating in planar relation with each respective side surface of the disk-shaped body.

9. The rotating scissor ring of claim 1 further comprising a coating comprising an admixture of thin, dense, chrome coating and synthetic nano-diamond particulates applied in a chemical bath along at least a portion of the outer peripheral surface along one of the first finger knives and the second finger knives.

10. The scissor ring of claim 1 wherein the first finger knives are larger than the second finger knives.

11. The scissor ring of claim 10 wherein the first finger knives have a sharp knife point extending radially outwardly a greater distance than a corresponding sharp knife point on the second finger knives.

12. The scissor ring of claim 11 wherein seven first finger knives are spaced equidistant about the outer peripheral surface, and wherein one group of the second finger knives is provided between each pair of adjacent first finger knives.

13. The scissor ring of claim 12 wherein each group of second finger knives is five second finger knives spaced apart equidistant within the group along the outer peripheral surface between a respective pair of adjacent first finger knives.

14. A rotary cutting knife body, comprising:
a disk-shaped scissor ring having an outer peripheral surface including a circumferential array of first finger knives and second finger knives spaced apart about the outer peripheral surface, the first finger knives having a sharp knife point that extends radially outwardly a greater distance than a corresponding sharp knife point on the second finger knives, with a plurality of the second finger knives distributed between each adjacent pair of first finger knives.

15. The rotary cutting knife body of claim 14 wherein the circumferential array of first finger knives is distributed substantially equidistant about the outer peripheral surface of the scissor ring.

16. The rotary cutting knife body of claim 14 wherein the circumferential array of first finger knives comprises seven first finger knives and the circumferential array of second finger knives comprises 35 second finger knives.

17. The rotary cutting knife body of claim 14 further comprising a hexagonal inner peripheral surface configured to mount the scissor ring onto a hexagonal drive shaft.

18. The rotary cutting knife body of claim 14 further comprising a coating comprising nano-diamond particulates applied to at least a portion of the outer peripheral surface of the scissor ring in the vicinity of the first finger knives and the second finger knives.

19. The rotary cutting knife body of claim 14 wherein the scissor ring comprises a pair of substantially parallel side surfaces cooperating with the outer peripheral surface to provide shearing edges along the outer peripheral surface along a side shearing surface of each of the first finger knives and the second finger knives.

20. The rotary cutting knife body of claim 19 wherein the pair of side surfaces each provide a shearing edge along the entire outer peripheral surface including the first finger knives and the second finger knives.

21. The rotary cutting knife body of claim 14 wherein the first finger knives and the second finger knives are each configured in a circumferential array about the outer peripheral surface so as to provide a serrated shearing edge along an intersection of each side surface with the outer peripheral surface.

22. A comminuting apparatus, comprising:
a frame with an entrance opening for receiving waste material;
a set of overlapping scissor rolls carried for rotation by the frame, each scissor roll including a plurality of disk-shaped scissor rings each having an outer peripheral surface with a circumferential array of first finger knives and second finger knives spaced apart about the outer peripheral surface, the first finger knives having a sharp knife point that extends radially outwardly a distance greater than a corresponding sharp knife point on the second finger knives, with a plurality of the second finger knives distributed between each adjacent pair of the first finger knives; and
a recycle manifold provided downstream of the scissor rolls and configured to receive subdivided pieces of waste material.

23. The comminuting apparatus of claim 22 further comprising a screen carried by the frame beneath the scissor rolls and operative to permit undersized pieces of waste material of a size less than a predetermined size to pass therethrough and to prevent oversized pieces of a size greater than the predetermined size from passing therethrough.

24. The comminuting apparatus of claim 22 wherein each scissor ring is formed from a plate of hardened steel.

25. The comminuting apparatus of claim 24 wherein each scissor ring further comprises a coating on the outer peripheral surface of each scissor ring including a mixture of nano-diamond particulates and a thin, dense, chrome coating applied to the outer peripheral surface via a chemical bath.

26. The comminuting apparatus of claim 22 wherein each scissor ring comprises a pair of substantially parallel side surfaces communicating with the outer peripheral surface to provide a respective shearing edge along the outer peripheral surface as well as along a side shearing surface of each of the first finger knives and the second finger knives.

27. The comminuting apparatus of claim 26 wherein each shearing edge of each scissor ring provides a serrated shearing edge provided along an intersection of each side surface with the outer peripheral surface.

28. A method for subdividing plastic waste material, comprising:
providing a pair of overlapping scissor rolls and three adjacent, overlapping scissor rings, one scissor ring on one scissor roll and two scissor rings on another scissor roll, each scissor ring having an outer peripheral surface with a circumferential array of relatively large finger knives and a plurality of relatively small finger knives provided between each pair of adjacent relatively large finger knives, the relatively large and small finger knives of the outer peripheral surface cooperating with opposed sides of the scissor ring to provide a pair of serrated shearing edges;
counter-rotating the pair of overlapping scissor rolls;
moving a web of plastic material between the pair of counter-rotating, overlapping scissor rolls;
severing a strip of material from the sheet of material along side edges via the three adjacent, overlapping scissor rolls;
crinkling the strip of material as the material passes through an overlap zone of the serrated shearing edges cooperating between the three adjacent scissor rings; and
severing the strip of material between the three overlapping scissor rings with one of the first finger knives on the one scissor ring as the one, first finger knife approaches a maximum overlap depth relative to the opposed, adjacent scissor rings so as to sever the strip at a trailing end from the sheet of material.

29. The method of claim 28 wherein severing of a strip of material along side edges occurs concurrently with crinkling the strip of material.

30. The method of claim 28 wherein crinkling comprises forming creases between a leading end and a trailing end of the strip of material that segment the strip of material into a plurality of segments out of plane with adjacent segments.
